(19) United States
(12) Patent Application Publication
(10) Pub. No.: US 2026/0346491 A1
(43) Pub. Date: Nov. 5, 2026

(54) PUNCHING CELL FOR PUNCHING WORKPIECES

(71) Applicant: ABB SCHWEIZ AG, BADEN (CH)

(72) Inventors: Andrés GRANADERO SABRIDO, Sant Quirze del Vallès (ES); Jesús PALLARÉS MARTÍNEZ, Sant Quirze del Vallès (ES); Jordi FONT VENTURA, Sant Quirze del Vallès (ES)

(21) Appl. No.: 19/740,856

(22) Filed: Jul. 14, 2026

Related U.S. Application Data
(63) Continuation-in-part of application No. 18/160,637, filed on Jan. 27, 2023.

(30) Foreign Application Priority Data
Jan. 28, 2022 (EP) 22382075.4

(51) Int. Cl. B26F 1/14; B25J 11/00; B26D 7/01; B26D 7/08

(52) U.S. Cl. CPC B26F 1/14; B25J 11/0055; B26D 7/01; B26D 7/086

(57) ABSTRACT

In one embodiment, a punching cell for punching holes in workpieces is provided. The punching cell comprises an industrial robot, a plurality of toolings, a support fixture, a tooling storage, and a control unit. The support fixture includes a plurality of presence sensors configured to provide information to align the workpiece at a predetermined position. The control unit is configured to direct the industrial robot to attach a first tooling stored in the tooling storage, move a puncher tool of the first tooling to a first punching position on the workpiece, utilize the puncher tool to punch a first hole in the workpiece, place the first tooling in the tooling storage, attach a second tooling stored in the tooling storage, move the puncher tool of the second tooling to a second punching position on the workpiece, and utilize the puncher tool to punch a second hole in the workpiece.

### CROSS-REFERENCE TO RELATED APPLICATIONS

This application claims priority to, and is a continuation-in-part of, United States Patent Application No. 18/160,637, filed Jan. 27, 2023 and identically titled, which claims priority to European Patent Application No. 22382075.4, filed Jan. 28, 2022 and titled “A PUNCHING CELL FOR PUNCHING WORKPIECES”, the entire contents of each of which are hereby incorporated by reference.

### TECHNICAL FIELD

The present disclosure relates to a punching cell for punching holes in workpieces, the cell comprising an industrial robot and a support fixture for a workpiece.

### BACKGROUND

It is known to use custom designed punching cells for punching holes in workpieces such as vehicle bumpers, for example in a manufacturing line, such as a line employed for manufacturing vehicle body parts.

Holes may be punched in a vehicle bumper, for example, for housing the sensors associated with an automated parking system and may require a high degree of accuracy in their position and orientation.

Known punching cells are generally large and custom designed for a specific vehicle bumper model. The cell may comprise several punchers, and hydraulic systems to drive each puncher to form a hole in a specific and accurate position and orientation along the vehicle bumper. Although punching cells allow workpieces to be processed at a high rate, the cell has a high manufacturing cost, complexity, and weight. Furthermore, each punching cell is configured for a specific bumper model, or sometimes for a few bumper models, so every new bumper configuration requires a new punching cell, or an existing punching cell has to be redesigned. Moreover, since several bumpers of a certain model may be needed, for example, as spare parts, even after no new vehicles are fitted with that bumper model, known cells often need to be stored for years and are used only sporadically, thus taking up space and requiring a relevant investment.

The present disclosure aims at solving the problem of punching holes in workpieces such as vehicle bumpers in a reliable and accurate way, with a cost effective and flexible system which may be readily adapted to different designs of the workpiece to be punched, for example, to different models of vehicle bumpers, in which the position and/or inclination of the holes to be punched may vary from one workpiece to another, and therefore avoiding the need to provide different custom cells for different workpieces.

### BRIEF DESCRIPTION

In one embodiment, a punching cell for punching holes in workpieces is provided. The punching cell comprises an industrial robot, a plurality of toolings, a support fixture, a tooling storage, and a control unit. The industrial robot comprises a base, a wrist, a wrist tool coupling element arranged on the wrist, and at least four robot axes between the base and the wrist, where the wrist is rotatable about a wrist axis, the wrist axis being one of the at least four robot axes between the base and the wrist. Each of the plurality of toolings comprises a frame configured to detachably mount to the wrist tool coupling element, a puncher tool mounted on the frame, a puncher die mounted on the frame and aligned with the puncher tool, and a servomotor configured to drive the puncher tool towards the puncher die. The support fixture includes a plurality of presence sensors configured to provide information to align the workpiece at a predetermined position on the support fixture. The tooling storage is arranged proximate the industrial robot and is configured to hold the plurality of toolings. The control unit is configured to direct the industrial robot to engage the wrist tool coupling element to attach a first tooling of the plurality of toolings stored in the tooling storage to the wrist tool coupling element, move the puncher tool of the first tooling to a first punching position on the workpiece based on the predetermined position of the workpiece on the support fixture, utilize the puncher tool of the first tooling to punch a first hole having a first size at the first punching position, place the first tooling in the tooling storage and disengage the wrist tool coupling element to detach the first tooling from the wrist tool coupling element, engage the wrist tool coupling element to attach a second tooling of the plurality of toolings stored in the tooling storage to the wrist coupling tool element, move the puncher tool of the second tooling to a second punching position on the workpiece based on the predetermined position of the workpiece on the support fixture, and utilize puncher tool of the second tooling to punch a second hole having a second size at the second punching position on the workpiece.

In some embodiments, an industrial robot is used in combination with a tooling, which may comprise an ultrasonic puncher tool, allows punching holes in workpieces such as, for example, vehicle bumpers, in an accurate way, and may be readily adapted to workpieces of different design and configuration by virtue of the industrial robot's programming potential: the robot is able to place the puncher tool in different positions and orientations, depending on the design of the workpiece and the hole or holes to be formed.

In some embodiments, the industrial robot may be fitted with different detachable toolings, for example with different types of puncher tools and dies for different sizes and shapes of holes or openings to be formed, or for example, for different workpiece materials or thicknesses, in a flexible way.

In order to punch holes in each different workpiece, different parameters have to be taken into account, such as parameters regarding the material of the workpiece, the type of paint coating on the workpiece, the geometry of the workpiece and the specific place of the hole to be punched therein.

More specifically, the inclination of the puncher tool regarding the surface of the workpiece is important since it defines the shape of the hole. If, for example, a puncher tool having a cylinder-shaped tip punches a hole in a workpiece with a flat surface in a perpendicular manner, the resulting hole would be a circular-shaped hole. On the other hand, if the same puncher tool punches the hole obliquely, that is, at an angle different from 90º with respect to the flat surface of the workpiece, the resulting hole would be an ellipse.

Therefore, the shape of the surface of the workpiece and the shape of the desired hole have to be considered when designing the shape of a puncher tool (and, usually, its tip), the angle at which it will punch the surface of the workpiece, and the position of the hole within the overall workpiece.

An ultrasonic puncher may vibrate between 10KHz-70KHz, and it may penetrate the workpiece material (which may usually be, in the case of vehicle bumpers, a plastic material), without the need of applying high pressure on the tool. This results in low deformation of the workpiece material, thus avoiding cracks or weak spots proximate the hole. Furthermore, a precise, uniform, and clean finish of the resulting punched hole is achieved, lessening the burrs surrounding the hole. Additionally, by using an ultrasonic puncher, different types of rounded edges may be achieved along the resulting hole, thus adapting the holes to house different devices, or simplifying the insertion thereof in the hole. Such devices may be for example, vehicle lights, sensors, such as parking sensors, or other.

Alternatively, according to the embodiments described herein, other type of punchers may be used such as punchers without ultrasonic equipment. However, such punchers may need a high amount of driving force when punching a workpiece, thus resulting in an equipment bigger than ultrasonic driven punchers, to achieve a similar result.

In some embodiments, several interchangeable toolings may be provided, for example, each tooling having a puncher tool for a certain size or type of hole, and the industrial robot may process a workpiece having different types of holes by using a first tooling to punch a first hole, and successively releasing the first tooling and fetching a second tooling to punch a second hole, different from the first hole. In some embodiments, the toolings required for a particular workpiece may be releasably mounted in the puncher cell, within the reach of the industrial robot, and may be provided with a quick tool changer, such that the replacement of one tooling with another may be performed by the industiral robot, and any down time for manual intervention in the replacement of the toolings may be avoided.

In some embodiments, the control unit may further control the positioning of the workpiece on the fixture.

For example, the control unit may receive a control signal from presence sensors within in the support fixture, thus monitoring the correct positioning of a workpiece on the fixture. Once the workpiece is correctly positioned on the support fixture, the control signal may indicate the control unit to go ahead with the punching operation of the industrial robot.

In some embodiments, the support fixture may comprise a plurality of presence sensors such as inductive sensors, capacitive sensors, optic sensors, or a combination thereof. The sensors may be connected to a programmable logic controller (PLC) unit, which in turn may be connected to the control unit. Therefore, when in use, an operator may place a workpiece on the support fixture, and the sensors may monitor a correct positioning of the workpiece by means of the presence sensors. When a correct positioning of the workpiece has been performed, the presence sensors may send a control signal to the PLC unit indicating such correct positioning. Then, the PLC unit may further send a control signal to the control unit indicating to proceed with the punching operation of the industrial robot.

In some embodiments, the controlling of the positioning of the workpiece may be implemented, using alternative configurations with or without the use of a PLC unit.

Furthermore, in some embodiments, the frame of the tooling may be c-shaped, which allows more flexibility to position the puncher tool and the die in different relative positions with respect to the workpiece.

In some embodiments, the servomotor may drive the puncher tool towards the die, to punch the workpiece, through a linear actuator that converts rotary motion into linear motion. Mechanical actuators are the simplest form of linear actuators which convert rotary motion into linear motion. Some examples of mechanical linear actuators may be ball screw actuators, leadscrew actuators, rack and pinion actuators, belt driven actuators, or cam actuators. The operation of such actuators may involve a screw, known as a lead screw, creating motion by turning clockwise or counter clockwise, causing a lead nut on the screw to move, thus creating a linear motion. The use of such mechanical actuators may be a structurally simple solution, while enhancing the precision of the punching operation.

According to another embodiment, the linear actuator may comprise a ball screw actuator. This way, especially when the puncher tool extends in a horizontal or inclined direction, the direction of advance of the puncher tool while punching the hole may be accurately controlled, without for example, a deviation caused by the weight of the tooling or the puncher itself.

Alternatively, in some embodiments, a rack and pinion actuator may be used to drive the puncher tool towards the die, the rack being attached to the puncher tool, and the pinion being driven by the servomotor.

According to an embodiment, the servomotor may be an electric motor servomotor, outputting a rotational movement to move the linear actuator. Also, the servomotor may alternatively be a hydraulic actuator instead of an electric motor. However, hydraulic actuators may be a bigger solution that electric motors, to achieve same result as electric motors.

In another embodiment, a method for punching holes in a workpiece utilizing an industrial robot is provided. The method comprises placing the workpiece on a support fixture, where the support fixture includes a plurality of presence sensors configured to provide information to align the workpiece at a predetermined position on the support fixture, engaging a wrist tool coupling element of the industrial robot to attach a first tooling stored in a tooling storage to the wrist tool coupling element, moving a puncher tool of the first tooling to a first punching position on the workpiece based on the predetermined position of the workpiece on the support fixture, utilizing the puncher tool of the first tooling to punch a first hole having a first size at the first punching position, placing the first tooling in the tooling storage and disengaging the wrist tool coupling element to detach the first tooling from the wrist tool coupling element, engaging the wrist tool coupling element to attach a second tooling stored in the tooling storage to the wrist coupling tool element, moving a puncher tool of the second tooling to a second punching position on the workpiece based on the predetermined position of the workpiece on the support fixture, and utilizing the puncher tool of the second tooling to punch a second hole having a second size at the second punching position on the workpiece.

### BRIEF DESCRIPTION OF THE DRAWINGS

Non-limiting examples of the present disclosure will be described with reference to the following drawings.

FIG. 1A depicts a perspective view of a punching cell in an exemplary embodiment.

FIG. 1B depicts a perspective view of an alternative punching cell in an exemplary embodiment.

FIG. 2A depicts a perspective view of an industrial robot and support fixture in an exemplary embodiment.

FIG. 2B and FIG. 2C depict a tooling storage in an exemplary embodiment.

FIG. 3A and FIG. 3B depict a tooling in an exemplary embodiment.

FIG. 4 depicts a flow chart of a method for punching holes in a workpiece utilizing an industrial robot in an exemplary embodiment.

FIG. 5A, FIG. 5B, and FIG. 5C depict block diagrams of an industrial robot, a support fixture, and a tooling, respectively, in exemplary embodiments.

### DETAILED DESCRIPTION

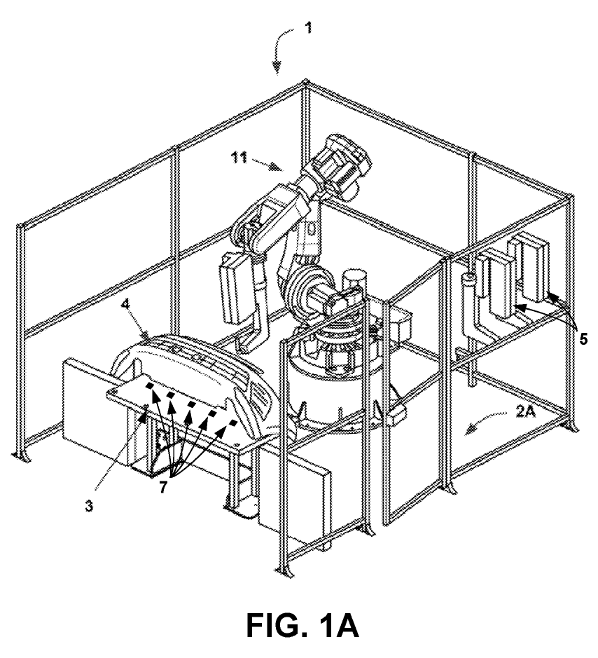

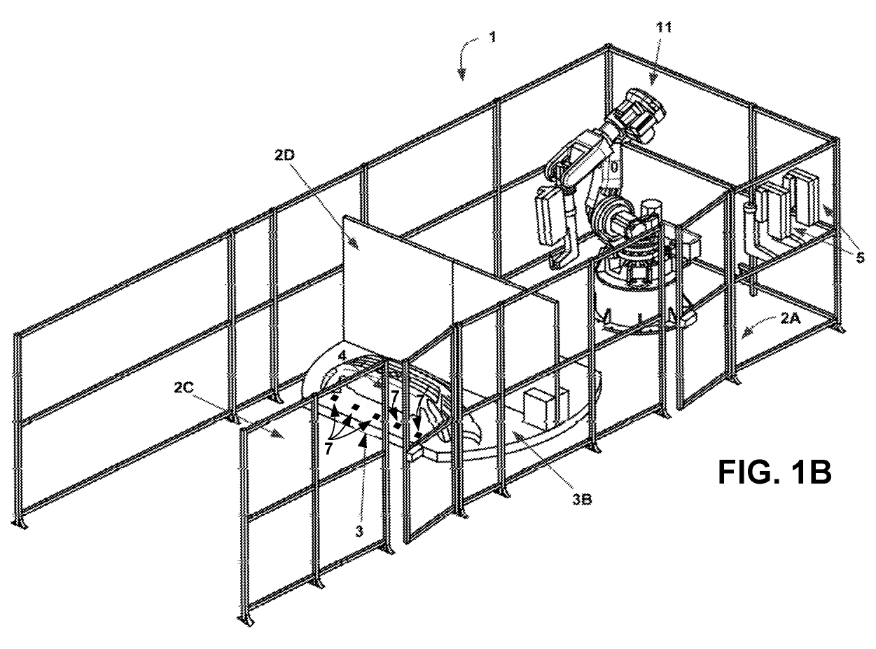

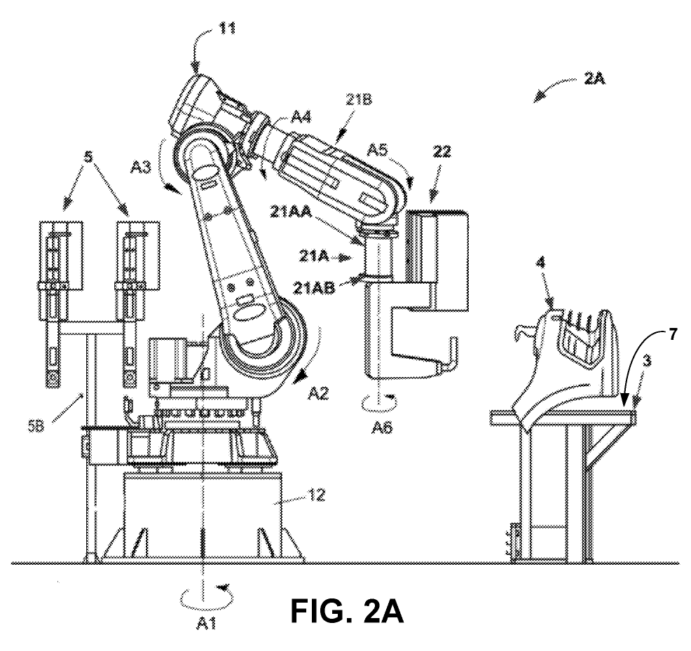

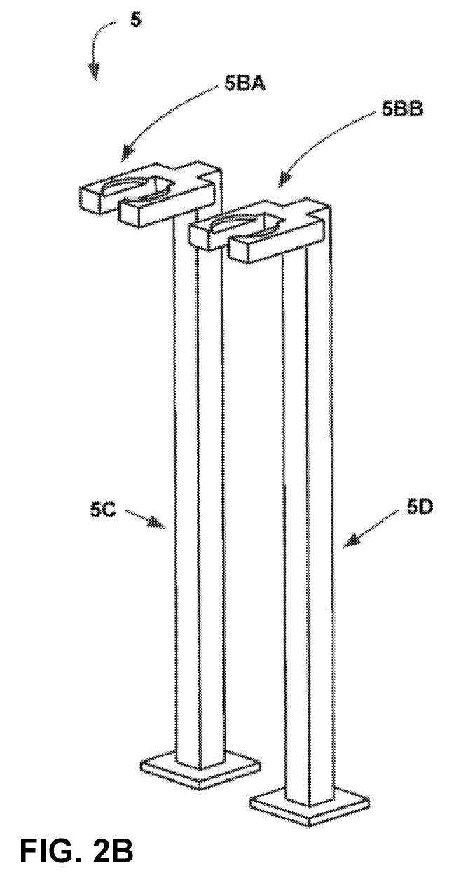

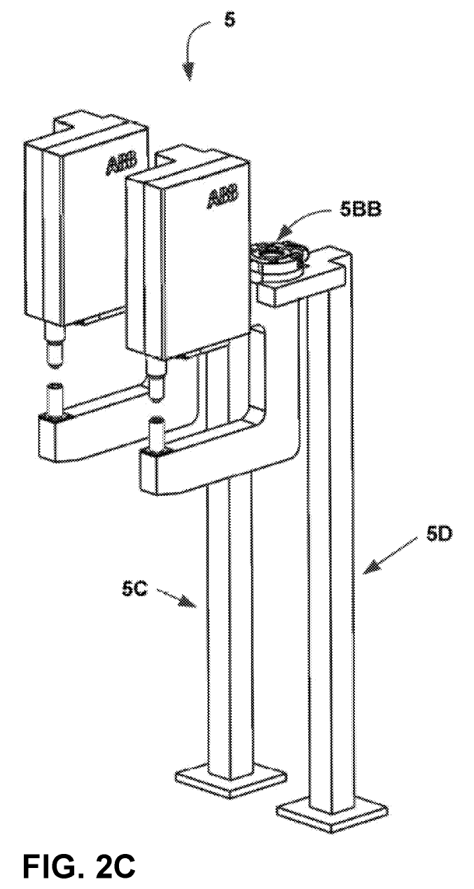

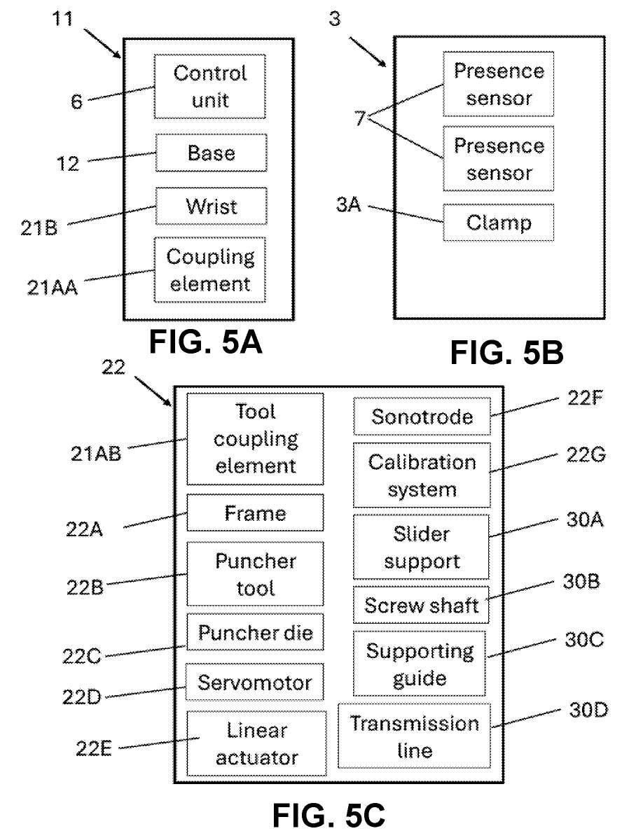

FIG. 1A depicts a perspective view of a punching cell 1 in an exemplary embodiment, FIG. 1B depicts a perspective view of an alternative punching cell in an exemplary embodiment, and FIG. 5A, FIG. 5B, and FIG. 5C depict block diagrams of an industrial robot 11, a support fixture 3, and a tooling 22, respectively, in exemplary embodiments. Punching cell 1 in FIG. 1A includes industrial robot 11, for example, in a working area 2A of punching cell 1; a support fixture 3 to hold workpieces 4 in a predetermined position, to be punched by industrial robot 11. FIG. 2A depicts a perspective view of industrial robot 11 and support fixture 3 in an exemplary embodiment. Industrial robot 11 may be, for example, a robot comprising at least four axes A1-A6 between a robot base 12 and a wrist 21B. A suitable commercial robot may be for example model known as IRB 6620, available from ABB LTD (Zurich).

Punching cell 1 also includes a control unit 6 (see FIG. 5A) to control the operation of industrial robot 11 to punch a hole in workpiece 4. Control unit 6 may further control the positioning of workpiece 4 on support fixture 3. Support fixture 3 comprises at least one clamp 3A (see FIG. 5B) to fix workpiece 4 into a work position. Control unit 6 may receive a control signal from a plurality of presence sensors 7 (see also (see FIG. 5B) located in support fixture 3, thus monitoring the correct positioning of workpiece 4 on support fixture 3. The presence sensors are represented schematically in FIGS. 1A, 1B and 5B. Once workpiece 4 is correctly positioned on support fixture 3 based on information provided by presence sensors 7 (by an operator, for example), a control signal may indicate to control unit 6 to proceed with the punching operation by industrial robot 11. In some embodiments, the plurality of presence sensors 7 may be inductive sensors, capacitive sensors, optic sensors, or a combination thereof. Presence sensors 7 may be located in a surface or on a surface of support fixture 3 in different embodiments. Although a specific number and placement of presence sensors are shown in FIG. 1A and FIG. 1B, the location of presence sensors 7 and/or the number of presence sensors 7 on or in support fixture 3 may vary in other embodiments.

As shown in FIG. 1B, support fixture 3 may be mounted on a rotatable platform 3B, such that a protective screen 2D may divide a space in front of industrial robot 11 between working area 2A and an operator area 2C. Operator area 2C is used by an operator to place workpiece 4 on support fixture 3, which is positioned along the top of rotatable platform 3B. Protective screen 2D may function as a separation between operator area 2C where the operator is placing workpiece 4 on support fixture 3 or picking up workpiece 4 after being punched, and in working area 2A, industrial robot 11 operates to punch workpieces 4 located on support fixture 3. In this embodiment of alternative punching cell 1, workpiece 4 can be safely put on support fixture 3 by an operator, rotated 180º, punched by industrial robot 11 and rotated back again when the operation is finished, so the operator can pick up the finished workpiece 4 in a safe manner.

Furthermore, as seen in both FIG. 1A and FIG. 1B, punching cell 1 may also comprise a tooling storage 5. Tooling storage 5 may hold toolings 22 (see FIG. 5C) to be used in punching operations by industrial robot 11. Each tooling 22 may be fixed to tooling storage 5 by means of a supporting structure, which may comprise holding means, such as pneumatic, mechanical, or vacuum systems. For example, some of toolings 22 may be held by hooks which comprise a pneumatic system to adjust and securely grasp toolings 22 within tooling storage 5. Alternatively, toolings 22 may be held by suction pads, which may grasp toolings 22 by means of a vacuum circuit formed within the suction pads. Other types of holding means may be used within tooling storage 5 based on the configuration of punching cell 1 and the number of toolings 22 needed for a specific operation (for example, a specific workpiece may need more or less toolings 22, thus determining the type of holding means to be used on tooling storage 5, based on the space needed to store said number of toolings 22). In the embodiments of FIG. 1A and FIG. 1B, two toolings 22 are hanging from a hook fixed to the outer structure of punching cell 1.

FIG. 2A is a perspective view of industrial robot 11 and support fixture 3 in an exemplary embodiment. In this embodiment, FIG. 2A shows an alternative example of tooling storage 5, where the two toolings 22 are hanging from a tooling pillar 5B, which is fixed to the floor. FIG. 2B and FIG. 2C show tooling storage 5 in another exemplary embodiment. In FIG. 2B and FIG. 2C, a detailed view of two exemplary supporting pillars 5C and 5D is shown. More specifically, FIG. 2B shows pillars 5C and 5D on their own, showing a locking mechanism each 5BA and 5BB at one end of the corresponding pillars 5C and 5D. Such mechanisms are configured to hold and lock a tooling 22. FIG. 2C shows pillars 5C and 5D supporting a tooling 22 each, wherein the corresponding locking mechanisms are supporting a corresponding tooling 22.

Referring again to FIG. 2A, a more detailed part of working area 2A depicts industrial robot 11 and support fixture 3, and a tooling 22 is attached to industrial robot 11 by means of a tool changer 21A.

Tool changer 21A may be formed by a coupling element 21AA attached to a wrist 21B of industrial robot 11, and a matching tool coupling element 21AB attached to tooling 22. Tool changer 21A, also known as a quick-change device, may be a coupling device with two cooperating and mating parts, usually referred to as master plate and tool plate, which are designed to lock or couple together, either manually or automatically, and can pass from one side to the other utilities such as electric or pneumatic signals, and/or other. The master plate and the tool plate may also be designed to carry a payload. The master plate may be attached to wrist axis A6 of industrial robot 11 and carries a locking mechanism, for example mechanical or pneumatic, and the tool plate is attached to tooling 22 and carries suitable elements to be engaged by the locking mechanism of the master plate. Tool changer 21A employed in embodiments of the present disclosure may be of any known type, for example, it may be an automatic tool changer that uses a pneumatic system to lock the two parts together (in this case, coupling element 21AA and tool coupling element 21AB).

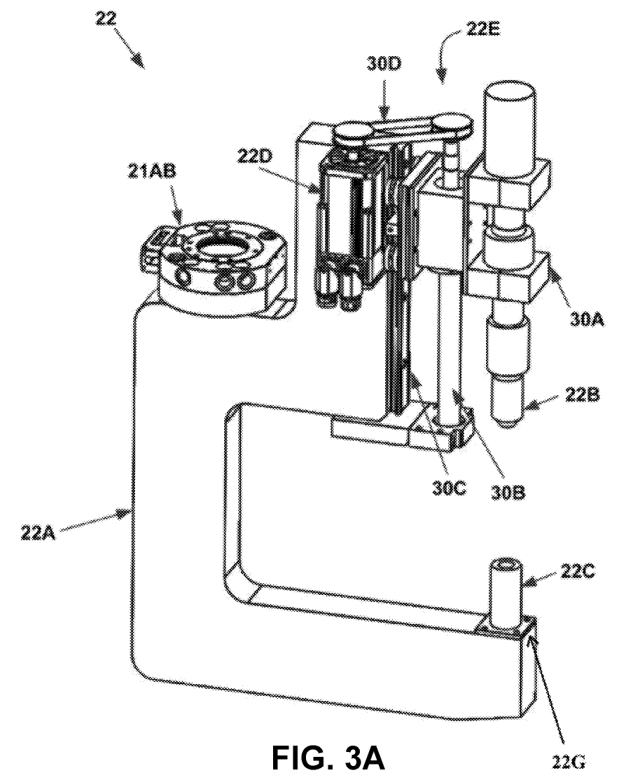

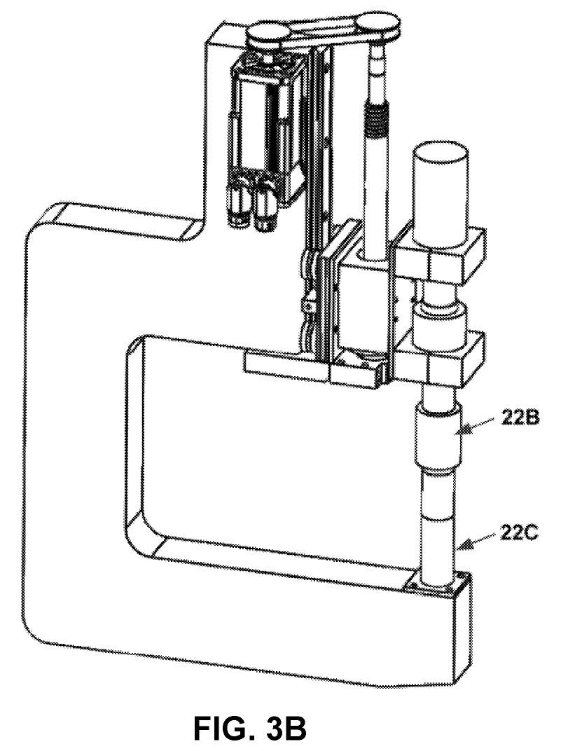

FIG. 3A and FIG. 3B depict tooling 22 in an exemplary embodiment. Support fixture 3 is also mounted in working area 2A, to support workpiece 4 to be punched by a puncher tool 22B of tooling 22 that is held and operated by industrial robot 11. Puncher tool 22B in this embodiment is mounted on a frame 22A. In some embodiments, puncher tool 22B comprises an ultrasonic puncher tool, for example, a sonotrode 22F.

In the embodiments described herein, workpiece 4 may be a vehicle bumper, in which a number of holes need to be punched, in predetermined positions and with predetermined specifications (for example, diameter, orientation, etc.) in order to house, for example, parking sensors for the front of a vehicle. As shown, industrial robot 11 is within reach of the support fixture 3 and in a predetermined position with respect to the support fixture, such that industrial robot 11 can reach parts of workpiece 4 to punch one or more holes in workpiece 4, following pre-programmed instructions. This way, industrial robot 11 may, based on a model of workpiece 4 (for example, a certain model of vehicle bumper), punch holes in predetermined locations of workpiece 4.

FIG. 3A and FIG. 3B show a detailed depiction of tooling 22 of industrial robot 11, in two different operating positions respectively. In FIG. 1A, FIG. 1B, and FIG. 2A, the mechanical elements of tooling 22 are partially covered by a protective box. However, in FIG. 3A and FIG. 3B, tooling 22 is shown without the protective box.

More precisely, as seen in FIG. 3A, tooling 22 may comprise frame 22A, which may be C-shaped, as described previously. Furthermore, a punching system may be mounted on frame 22A. More specifically, in this embodiment, the punching system may comprise a servomotor 22D mounted on frame 22A; a linear actuator 22E connected to servomotor 2D, to convert the rotary motion of servomotor 22D into a linear displacement; and puncher tool 22B, which is driven by linear actuator 22E.

In some embodiments, linear actuator 22E may comprise a mechanical linear actuator having a shaft and a nut with matching threads, where the nut travels along the shaft when the shaft rotates, or conversely, the shaft is displaced axially when the nut rotates.

In some embodiments, linear actuator 22E may comprise a ball screw drive comprising a screw shaft and a ball nut, which may provide accuracy in the movement and positioning.

In this embodiment, puncher tool 22B may be attached to the ball nut, with its axis parallel to screw shaft 30B, and the displacement of the nut therefore may drive puncher tool 22B in axial direction. For example, puncher tool 22B may be moved in a vertical direction, if industrial robot 11 is holding tooling 22 in a position in which screw shaft 30B and the axis of puncher tool 22B are vertical, so as to punch a hole vertically in workpiece 4, as illustrated in FIG. 2A. For punching a hole in a different direction, for example, horizontal or inclined, industrial robot 11 may hold tooling 22 in an orientation in which screw shaft 30B and the axis of puncher tool 22B are horizontal or inclined.

In other embodiments, linear actuator 22E may comprise a lead screw drive, a pinion and rack system, or other types of mechanical systems.

In the embodiment of FIG. 3A, frame 22A further comprises a tool coupling element 21AB, to attach tooling 22 to wrist 21B of industrial robot 11, by means of the previously described tool changer 21A.

Furthermore, as seen in FIG. 3A, a corresponding puncher die 22C is also mounted on frame 22A, in such a way that it is aligned with the axis of puncher tool 22B, which allows punching the holes in a precise manner.

In the embodiment of FIG. 3A, linear actuator 22E comprises a ball screw actuator, comprising a slider support 30A, puncher tool 22B mounted on slider support 30A, and puncher die 22C mounted on frame 22A, such that puncher tool 22B and puncher die 22C are aligned to punch workpiece 4 by driving puncher tool 22B, which is movable, towards puncher die 22C, which is fixed. Furthermore, linear actuator 22E in this embodiment comprises a screw shaft 30B, where a slider support 30A is coupled to screw shaft 30B and to a supporting guide 30C.

Supporting guide 30C may be used as a supplementary support for linear actuator 22E, to provide additional security and fixation to slider support 30A when moving along screw shaft 30B, thereby ensuring that the movement is as parallel as possible to screw shaft 30B. Alternatively, a guided cylinder may also be used instead of supporting guide 30C, although a guided cylinder may need higher maintenance than supporting guide 30C (that is, more lubrication than a guide, with repeated movement).

In this embodiment, servomotor 22D is coupled to screw shaft 30B through a transmission line 30D, which rotates screw shaft 30B using servomotor 22D. Upon rotation of screw shaft 30B, a mechanical gear found within linear actuator 22E drives slider support 30A along screw shaft 30B, translating a rotation of screw shaft 30B into a linear movement of slider support 30A. During operation, puncher tool 22B (which is mounted on slider support 30A) is linearly displaced towards or away from puncher die 22C upon operation of servomotor 22D, to punch a hole in workpiece 4 which is located in between puncher tool 22B and puncher die 22C.

In FIG. 3A, puncher tool 22B and puncher die 22C are positioned in a passive position, such that workpiece 4 may be placed between puncher tool 22B and puncher die 22C to punch a hole. In FIG. 3B, puncher tool 22B and puncher die 22C are displaced and in a punching position, such that when workpiece 4 is previously placed in between puncher tool 22B and puncher die 22C, a hole is punched in workpiece 4 by means of puncher tool 22B approaching puncher die 22C and perforating a material of workpiece 4.

In some embodiments, tooling 22 may also comprise a calibration system 22G (see FIG. 6C) to align puncher die 22C with puncher tool 22B. For example, puncher die 22C may be fixed to frame 22A with a plurality of screws. The holes on the puncher piece used to screw puncher die 22C to frame 22A may be bigger than the actual screw, so there is room to adjust puncher die 22C to align puncher die 22C with puncher tool 22B in a more precise way.

Referring again to FIG. 5C, a ball screw actuator is a mechanical gear that converts a rotary motion of a drive shaft of servomotor 22D into a linear displacement of slider support 30A along, in this case, an axis of screw shaft 30B. Generally, the ball screw actuator comprises a ball case, and within the case it includes a nut configured to be driven by screw shaft 30B, where the nut and screw shaft 30B include matching helical grooves. In some embodiments, the ball screw actuator further comprises a plurality of balls (not shown) connected to each other which roll between the grooves and provide the only contact between the nut and screw shaft 30B. Thus, as screw shaft 30B rotates, the balls are deflected by a deflector into a ball return system of the nut, travelling through it to the opposite end of the nut in a continuous path. The balls then exit from the ball return system into the ball screw actuator and nut thread raceways in a continuous manner, to recirculate in a closed circuit within the ball screw actuator.

In this case, the ball case of the ball screw actuator is attached to slider support 30A. Therefore, upon rotation of the drive shaft of servomotor 22D, the nut of the ball screw actuator initiates the rotary motion, and the balls begin moving along the thread of the nut, performing the translational motion of the ball case along screw shaft 30B, moving slider support 30A and puncher tool 22B towards or away from puncher die 22C.

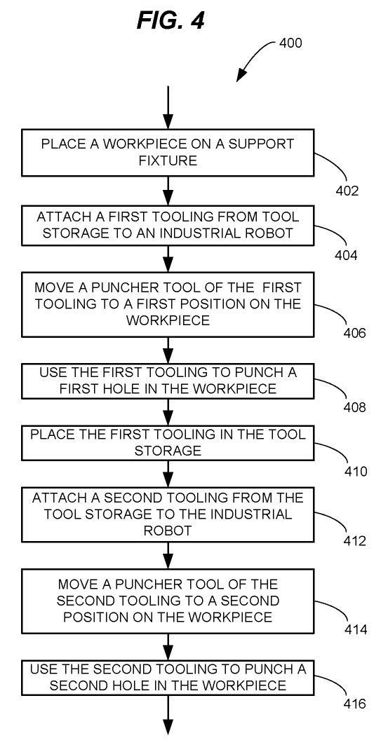

FIG. 4 is a flow chart of a method 400 for punching holes in a workpiece utilizing an industrial robot in an exemplary embodiment. Method 400 will be described with respect to industrial robot 11 of FIG. 1A, FIG. 5A, FIG. 5B, and FIG. 5C, although method 400 may be performed by other robots, not shown.

Method 400 comprises placing (402) the workpiece on a support fixture, where the support fixture includes a plurality of presence sensors configured to provide information to align the workpiece at a predetermined position on the support fixture. For example, an operator (not shown) places workpiece 4 on support fixture 3, and presence sensors 7 provide information to the operator that allows the operator to reposition workpiece 4 on support fixture 3 until workpiece 4 is at a predetermined position on support fixture 3 (see FIG. 1).

Method 400 further comprises engaging (404) a wrist tool coupling element of the industrial robot to attach a first tooling stored in a tooling storage to the wrist tool coupling element. For example, coupling element 21AA of industrial robot 11 is used to attach a first tooling 22 stored in tool storage 5 to coupling element 21AA (see FIG. 5A).

Method 400 further comprises moving (406) a puncher tool of the first tooling to a first punching position on the workpiece based on the predetermined position of the workpiece on the support fixture. For example, industrial robot 11 moves puncher tool 22B of first tooling 22 to a first punching position on workpiece 4 based on the predetermined position of workpiece 4 on support fixture 3 (see FIG. 1 and FIG. 5C).

Method 400 further comprises utilizing (408) the puncher tool of the first tooling to punch a first hole having a first size at the first punching position. For example, industrial robot 11 utilizes puncher tool 22B of first tooling 22 to punch a first hole having a first size at the first punching position (see FIG. 1 and FIG. 5C).

Method 400 further comprises placing (410) the first tooling in the tooling storage and disengaging the wrist tool coupling element to detach the first tooling from the wrist tool coupling element. For example, industrial robot 11 places first tooling 22 in tooling storage 5 and disengages coupling element 21AA to detach first tooling 22 from coupling element 21AA (see FIG. 1 and FIG. 5C).

Method 400 further comprises engaging (412) the wrist tool coupling element to attach a second tooling stored in the tooling storage to the wrist coupling tool element. For example, industrial robot 11 engages coupling element 21AA to attach second tooling 22 stored in tool storage 5 to coupling element 21AA (see FIG. 1 and FIG. 5C).

Method 400 further comprises moving (414) a puncher tool of the second tooling to a second punching position on the workpiece based on the predetermined position of the workpiece on the support fixture. For example, industrial robot moves puncher tool 22B of second tooling 22 to a second punching position on workpiece 4 based on the predetermined position of workpiece 4 on support fixture 4 (see FIG. 1 and FIG. 5C).

Method 400 further comprises utilizing (416) the puncher tool of the second tooling to punch a second hole having a second size at the second punching position on the workpiece. For example, industrial robot 11 utilizes puncher tool 22B of second tooling 22 to punch a second hole having a second size at the second punching position (see FIG. 1 and FIG. 5C).

In some embodiments, method 400 further comprises operating the servomotor of the first tooling to drive the puncher tool of the first tooling towards the puncher die of the first tooling. For example, industrial robot 11 operates servomotor 22D of first tooling 22 to drive puncher tool 22B of first tooling 22 towards puncher die 22C of fist tooling 22 (see FIG. 5C).

In some embodiments, method 400 further comprises utilizing a tooling calibration system to align the puncher tool of the first tooling with the puncher die of the first tooling. For example, industrial robot 11 utilizes tool calibration system 22G to align puncher tool 22B of first tooling 22 with puncher die 22C of first tooling 22.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A punching cell for punching holes in workpieces, the punching cell comprising:
an industrial robot comprising a base, a wrist, a wrist tool coupling element arranged on the wrist, and at least four robot axes between the base and the wrist, wherein the wrist is rotatable about a wrist axis, the wrist axis being one of the at least four robot axes between the base and the wrist;
a plurality of toolings, each tooling of the plurality of toolings comprising:
a frame configured to detachably mount to the wrist tool coupling element;
a puncher tool mounted on the frame;
a puncher die mounted on the frame and aligned with the puncher tool; and
a servomotor configured to drive the puncher tool towards the puncher die;
a support fixture to position a workpiece to be punched, wherein the support fixture includes a plurality of presence sensors configured to provide information to align the workpiece at a predetermined position on the support fixture;
a tooling storage arranged proximate the industrial robot that is configured to hold the plurality of toolings;
a control unit configured to direct the industrial robot to:
engage the wrist tool coupling element to attach a first tooling of the plurality of toolings stored in the tooling storage to the wrist tool coupling element;
move the puncher tool of the first tooling to a first punching position on the workpiece based on the predetermined position of the workpiece on the support fixture;
utilize the puncher tool of the first tooling to punch a first hole having a first size at the first punching position;
place the first tooling in the tooling storage and disengage the wrist tool coupling element to detach the first tooling from the wrist tool coupling element;
engage the wrist tool coupling element to attach a second tooling of the plurality of toolings stored in the tooling storage to the wrist coupling tool element;
move the puncher tool of the second tooling to a second punching position on the workpiece based on the predetermined position of the workpiece on the support fixture; and
utilize puncher tool of the second tooling to punch a second hole having a second size at the second punching position on the workpiece.

2. The punching cell of claim 1, wherein the control unit further controls a positioning of the workpiece on the support fixture to align the workpiece at the predetermined position.

3. The punching cell of claim 1, wherein the frame of each respective tooling of the plurality of toolings is C-shaped.

4. The punching cell of claim 1, wherein the support fixture comprises at least one clamp configured to hold the workpiece at the predetermined position on the support fixture.

5. The punching cell of claim 1, wherein the first tooling and/or the second tooling further comprises a linear actuator connected to the servomotor, the linear actuator configured to move the puncher tool towards the puncher die.

6. The punching cell of claim 5, wherein the linear actuator comprises a ball screw actuator.

7. The punching cell of claim 1, further comprising a complementary tool changer provided on the frame of at least one tooling of the plurality of toolings, the complementary tool changer configured to engage the wrist tool coupling element to detachably mount the frame to the wrist tool coupling element.

8. The punching cell of claim 1, wherein the puncher tool of at least one of the first tooling and the second tooling comprises an ultrasonic punching tool.

9. The punching cell of claim 1, further comprising a rotatable base comprising a screen dividing the base in at least two working areas, wherein the support fixture is mounted in one of the at least two working areas.

10. The punching cell of claim 1, wherein at least one of the first tooling and the second tooling further comprises a tooling calibration system configured to align the puncher tool with the puncher die.

11. The punching cell of claim 1, wherein the plurality of presence sensors comprise one or more inductive sensors, capacitive sensors, optic sensors, and combinations thereof.

12. The punching cell of claim 1, wherein at least one of the first tooling and the second tooling are removably secured to the tooling storage utilizing mechanical, pneumatic, and/or vacuum systems.

13. The punching cell of claim 1, wherein at least one of the first tooling and the second tooling are removably secured to tooling pillars of the tooling storage.

14. A method for punching holes in a workpiece utilizing an industrial robot, the method comprising:
placing the workpiece on a support fixture, wherein the support fixture includes a plurality of presence sensors configured to provide information to align the workpiece at a predetermined position on the support fixture;
engaging a wrist tool coupling element of the industrial robot to attach a first tooling stored in a tooling storage to the wrist tool coupling element;
moving a puncher tool of the first tooling to a first punching position on the workpiece based on the predetermined position of the workpiece on the support fixture;
utilizing the puncher tool of the first tooling to punch a first hole having a first size at the first punching position;
placing the first tooling in the tooling storage and disengaging the wrist tool coupling element to detach the first tooling from the wrist tool coupling element;
engaging the wrist tool coupling element to attach a second tooling stored in the tooling storage to the wrist coupling tool element;
moving a puncher tool of the second tooling to a second punching position on the workpiece based on the predetermined position of the workpiece on the support fixture; and
utilizing the puncher tool of the second tooling to punch a second hole having a second size at the second punching position on the workpiece.

15. The method of claim 14, wherein the puncher tool of at least one of the first tooling and the second tooling comprises an ultrasonic punching tool.

16. The method of claim 14, wherein each of the first tooling and the second tooling comprises:
a frame configured to detachably mount to the wrist tool coupling element;
the puncher tool mounted on the frame;
a puncher die mounted on the frame and aligned with the puncher tool; and
a servomotor configured to drive the puncher tool towards the puncher die,
wherein utilizing the puncher tool of the first tooling to punch the first hole further comprises:
operating the servomotor of the first tooling to drive the puncher tool of the first tooling towards the puncher die of the first tooling.

17. The method of claim 16, further comprising:
utilizing a tooling calibration system to align the puncher tool of the first tooling with the puncher die of the first tooling.
